(19) United States
(12) Patent Application Publication
(10) Pub. No.: US 2023/0410064 A1
(43) Pub. Date: Dec. 21, 2023

(54) ELECTRONIC RECEIPT SYSTEM, SERVER, AND METHOD FOR ELECTRONIC RECEIPT SYSTEM

(71) Applicant: Toshiba Tec Kabushiki Kaisha, Tokyo (JP)

(72) Inventors: Yuji HAYASHI, Tagata Shizuoka (JP); Takashi IIZUKA, Izunokuni Shizuoka (JP)

(21) Appl. No.: 18/183,865

(22) Filed: Mar. 14, 2023

(30) Foreign Application Priority Data
Jun. 17, 2022 (JP) 2022-098079

(51) Int. Cl. G06Q 20/04; G06Q 20/20; G06Q 20/38

(52) U.S. Cl. CPC G06Q 20/047; G06Q 20/209; G06Q 20/389

(57) ABSTRACT

An electronic receipt system has a first server to store first identification codes for store program members and a second server to store second identification codes set for people belong to an electronic receipt service operated by an entity other than the store. The first server stores first identification codes in association with second identification codes. A first control unit of the first server receives and then transmits receipt data including a second identification code to the second server. A second control unit of the first server receives receipt data including a first identification code and acquires a corresponding second identification code from the storage unit, adds the second identification code to the receipt data and transmits the receipt data to the second server without the including the first identification code.

### CROSS-REFERENCE TO RELATED APPLICATION

This application is based upon and claims the benefit of priority from Japanese Patent Application No. 2022-098079, filed Jun. 17, 2022, the entire contents of which are incorporated herein by reference.

### FIELD

Embodiments described herein relate to an electronic receipt system, a server for an electronic receipt system, and a method implemented in an electronic receipt system.

### BACKGROUND

If a person is a registered member of a store loyalty program (a “store member”) as well as a member (a “service member”) of electronic receipt service (for receiving digitized transaction receipts) to which the store has also contracted, then a receipt service ID associated with the person in the electronic receipt service can also be associated with a program member ID of the store loyalty program. By linking the receipt service ID with the program member ID, receipt data of a transaction can be managed (tracked) by receipt service IDs associated with the program member ID whenever the program member ID is input to a settlement terminal when the transaction is performed in the store. Since the program member ID is input to the settlement terminal, a service point can be given to the store member based on the transaction. Therefore, from a viewpoint of the store, there is an advantage that a consumer who wants electronic transaction receipts can be more easily recruited into being a store member. For the electronic receipt system, an increase in the number of service members can also be expected.

In the related art, the association between the receipt service ID and the program member ID is performed in a server system of the operator of the electronic receipt system. Therefore, it is generally necessary for the store to provide information about the store members to an outside operator (that is, the electronic receipt system operator). However, information about store members can be proprietary to the store and/or prohibited from being shared with third party operators. Furthermore, if the store member information leaks or is otherwise released to others, damage to the store's business position and reputation can be extremely large. In view of such circumstances, a mechanism is desired by which the association between the receipt service ID and the store's program member ID can be completed internally by the store so the information about the store member is not required to be provided to the server system of the electronic receipt system operator or the like.

### BRIEF DESCRIPTION OF THE DRAWINGS

FIG. 1 is a schematic diagram of an electronic receipt system.

FIG. 2 is a block diagram of a customer server.

FIG. 3 is a schematic diagram illustrating a data structure of a cooperation table.

FIG. 4 is a flowchart illustrating a procedure executed by a processor when a cooperation mode is selected.

FIG. 5 is a flowchart illustrating a procedure executed by a processor when a transaction mode is selected.

### DETAILED DESCRIPTION

In general, according to certain embodiments, an electronic receipt system in which a store member and a receipt member can be linked without providing store member information from a store to an electronic receipt system, and a server thereof are described.

According to one embodiment, an electronic receipt system includes a first server and a second server. The first server is configured to store first identification codes set for customers who are program members who have joined a customer program of a store. The second server is configured to store second identification codes set for receipt service members who have joined an electronic receipt service managed by an institution other than the store for receiving electronic transaction receipts from the store. The first server comprises a storage unit to store first identification codes of program members in association with second identification code for those who are also receipt service members, a first control unit configured to receive receipt data including a second identification code from a settlement terminal of the store for a customer transaction then transmit the receipt data with the received second identification code to the second server, and a second control unit configured to receive receipt data including a first identification code from the settlement terminal of the store for a customer transaction and acquire a second identification code stored in association with the received first identification code from the storage unit and add the acquired second identification code to the receipt data and transmit the receipt data to the second server without the including the first identification code.

An electronic receipt system according to one embodiment includes a first server and a second server. The first server and the second server are connected to each other via a communication network. The first server manages a first identification code set for each store member who makes a membership contract with a store. The second server manages a second identification code set for each receipt member who makes an electronic receipt contract for digitizing and receiving a transaction receipt with an institution outside the store.

In the electronic receipt system, the first server includes a storage unit, a first control unit, and a second control unit. The storage unit stores the first identification code of the store member and the second identification code set when the store member makes the electronic receipt contract with the institution in association with each other. The first control unit performs, when receipt data to which the second identification code is added is received from a settlement terminal of the store, control to transmit the receipt data to which the second identification code is added to the second server. The second control unit performs, when receipt data to which the first identification code is added is received from the settlement terminal of the store, control to acquire the second identification code stored in association with the first identification code from the storage unit, convert the first identification code added to the receipt data into the acquired second identification code, and transmit the receipt data to which the second identification code is added to the second server.

Hereinafter, non-limiting example embodiments will be described with reference to the drawings.

### Description of Electronic Receipt System

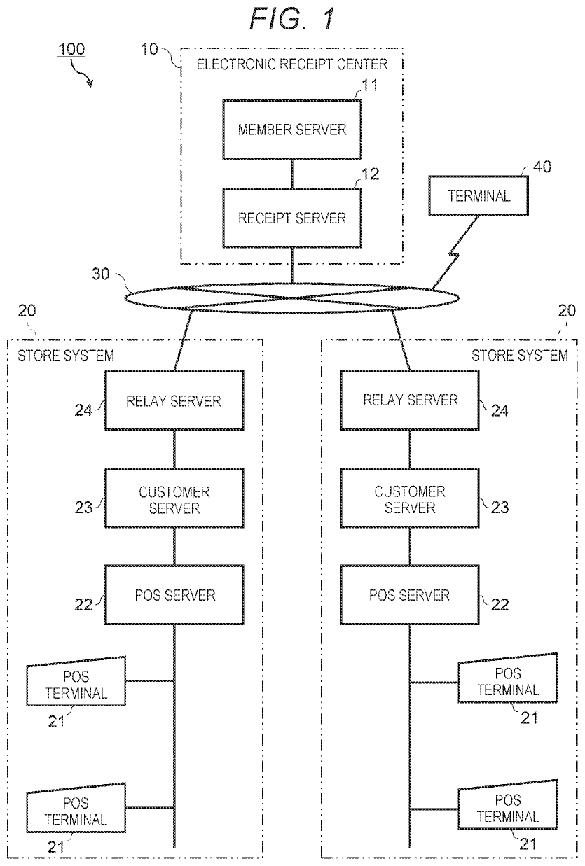

FIG. 1 is a schematic diagram illustrating a schematic configuration of an electronic receipt system 100 according to an embodiment. The electronic receipt system 100 includes an electronic receipt center 10, store systems 20, and a communication network 30.

The electronic receipt center 10 is a computer system of an institution that operates an electronic receipt service for digitizing transaction receipts and providing the digitized transaction receipt to a consumer via the Internet or the like. In this example, institution (entity) operating the electronic receipt service is an organization independent of the stores operating the store systems 20. That is, the institution is, for example, a separate company, corporation, enterprise, or the like distinct from at least one of the operators of the store systems 20.

The consumer who uses the electronic receipt service makes an electronic receipt contract with the institution. The electronic receipt contract is normally made online. The consumer installs application software dedicated to the electronic receipt service in a terminal 40 owned by the consumer. The terminal 40 is typically a smartphone. The terminal 40 may be a tablet terminal, a notebook computer, or the like. Hereinafter, this application software installed in the terminal 40 is referred to as an electronic receipt application. The consumer can make the electronic receipt contract with the institution by inputting necessary items of information into the terminal by using the electronic receipt application. The consumer who makes the electronic receipt contract is referred to as a receipt member or service member. A unique receipt member ID is set for each receipt member. When the electronic receipt application is activated in the terminal 40, a top (first) screen in which the receipt member ID is represented by a barcode is displayed on a touch panel of the terminal 40. The receipt member ID is an example of a second identification code set for each receipt member.

The electronic receipt center 10 includes a member server 11 and a receipt server 12. The member server 11 is a server for implementing a service for managing member information on each receipt member. The member information includes the receipt service ID set for the receipt member. The receipt server 12 is a server for implementing a service for managing digitized receipt data. The receipt server 12 also implements a service for downloading the receipt data to the terminal 40 used by the receipt member in response to a request from the receipt member.

The store system 20 is a system constructed in a store that makes a member store contract with the institution that operates the electronic receipt service. By making the member store contract, the store can digitize and provide the transaction receipt to the receipt member who settles the transaction in the store. A business category of the store is not particularly limited. The store may be a retail store such as a supermarket, a convenience store, or a specialized store, or may be a shopping center including a plurality of tenants. Alternatively, the store may be a facility that issues a receipt to a user, such as a hospital, a sports gym, a movie theater, or an amusement park.

The store system 20 includes point of sales (POS) terminals 21, a POS server 22, a customer server 23, and a relay server 24. The POS terminal 21 is a settlement terminal that processes the settlement of the transaction. The POS terminal 21 has a function of generating the receipt data for each settled transaction. The receipt data may be printed on a paper medium and issued as a transaction receipt, or may be transmitted to the receipt server 12. The number of the POS terminals 21 included in one store system 20 is not particularly limited. The store system 20 may include two or more POS terminals 21, or may include only one POS terminal 21.

The POS server 22 is a server for implementing a service for managing data of the transactions settled in the POS terminal 21. By managing the data of the transaction in the POS server 22, a store manager can know sales, loss, and the like of the store.

The customer server 23 is a server for implementing a service for managing information on the consumer who makes a membership contract with the store. The consumer can receive, for example, a point service by making the membership contract with the store. Alternatively, the consumer can purchase a product at a member price or use a facility. Hereinafter, the consumer who makes the membership contract is referred to as a store member. A unique member ID is set for the store member. The member ID is an example of a first identification code set for each store member. The information on the consumer, that is, the store member managed in the customer server 23 includes the member ID.

The relay server 24 is a server for implementing a service for providing the receipt data of the transaction settled in the POS terminal 21 to the electronic receipt center 10. The receipt data is provided from the relay server 24 to the receipt server 12 of the electronic receipt center 10 via a communication unit.

The communication network 30 is an example of the communication unit. The communication network 30 connects the relay server 24 of the store system 20 and the receipt server 12 of the electronic receipt center 10 to enable data communication. The communication network 30 is typically a wide area network using a public line or a dedicated line as a relay network and using a wired local area network (LAN), a wireless LAN, a mobile communication network, a mobile phone communication network, or the like as an access network. When the receipt server 12 uses cloud computing, the communication network 30 is mainly the Internet. The terminal 40 is also connected to the receipt server 12 via the communication network 30. The terminal 40 may be connected to the receipt server 12 via a network different from the communication network 30.

Here, the customer server 23 functions as a first server that manages the first identification code (member ID) set for each of the store members who make the membership contract with the store. The receipt server 12 functions as a second server that manages the second identification code (receipt service ID) set for each of the receipt members who make the electronic receipt contract for digitizing and receiving the transaction receipt with the institution outside the store.

### Description of Customer Server

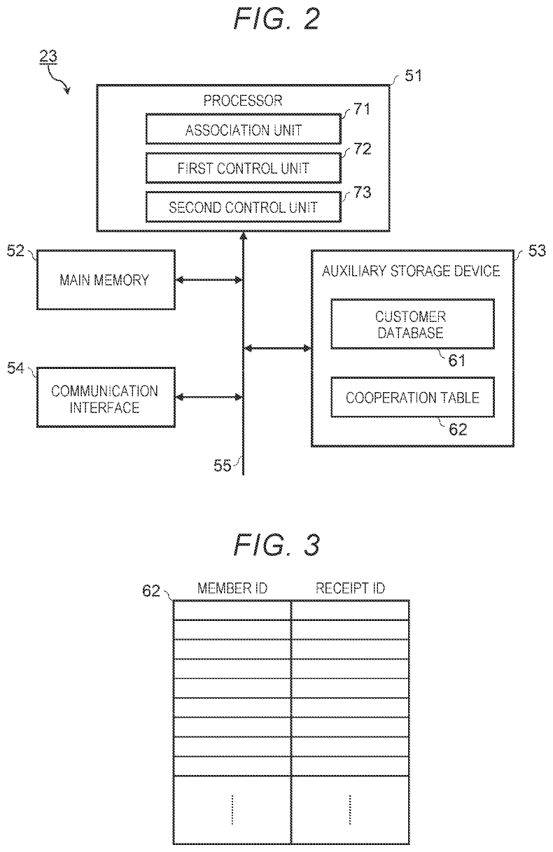

FIG. 2 is a block diagram of the customer server 23. The customer server 23 includes a processor 51, a main memory 52, an auxiliary storage device 53, a communication interface 54, and a system transmission path 55. The system transmission path 55 includes an address bus, a data bus, a control signal line, and the like. In the customer server 23, the processor 51, the main memory 52, the auxiliary storage device 53, and the communication interface 54 are connected to the system transmission path 55.

The processor 51 corresponds to a central part of a computer. The processor 51 controls the units to implement various described functions of the customer server 23 in accordance with an operating system and/or an application program (application software). The processor 51 is, for example, a central processing unit (CPU).

The main memory 52 includes a nonvolatile memory area and a volatile memory area. The main memory 52 stores the operating system and/or the application program in the nonvolatile memory area. The main memory 52 stores, in the volatile memory area, data necessary for the processor 51 to execute processing for controlling the units. The data may be stored in the nonvolatile memory area. The main memory 52 uses the volatile memory area as a work area in which the data is appropriately rewritten by the processor 51. The nonvolatile memory area is, for example, a read only memory (ROM). The volatile memory area is, for example, a random access memory (RAM).

For example, an electric erasable programmable read-only memory (EEPROM), a hard disc drive (HDD), a solid-state drive (SSD), or the like may serve as the auxiliary storage device 53. The auxiliary storage device 53 stores data used when the processor 51 performs various types of processing, data created by the processing in the processor 51, or the like. The auxiliary storage device 53 may store the application program.

The communication interface 54 is a circuit for performing data communication with the POS server 22 and the relay server 24. That is, the customer server 23 can perform the data communication, via the communication interface 54, with the POS server 22 and the POS terminals 21 connected to the POS server 22. The customer server 23 can also perform the data communication with the relay server 24 via the communication interface 54. Through these data communications, information on the transaction with the store member settled in the POS terminal 21 is managed by the customer server 23. If a store member is also a receipt member, the receipt data in which the transaction receipt is digitized is transmitted to the receipt server 12 via the relay server 24.

In the customer server 23, a part of a storage area in the auxiliary storage device 53 is used as a storage area of a customer database 61 and a cooperation table 62. The customer database 61 is a collection of customer data generated for each customer who is a store member. The customer data includes, in addition to personal information such as the member ID, a name, a gender, and a contact address, transaction history information such as accumulated service points or the like. Such customer data is generally proprietary to the store which generates it, and it is important that such data does not leak to the outside.

As illustrated in FIG. 3, the cooperation table 62 is a data table in which one program member ID and one receipt service ID are associated with each other. If the customer identified by the program member ID of the customer data managed by the customer database 61 is also a receipt member, the cooperation table 62 stores the program member ID for identifying the store member and the receipt service ID for identifying the receipt member in association with each other. The cooperation table 62 functions as a storage unit.

In the customer server 23 having such a configuration, the processor 51 has functions as an association unit 71, a first control unit 72, and a second control unit 73.

The association unit 71 has a function of confirming whether the program member ID is managed by the customer server 23 in association with a receipt service ID in an association table 63. Such a function as the association unit 71 is implemented when the processor 51 is in a cooperation mode.

The first control unit 72 has a function of performing control to transmit receipt data to the receipt server 12 when receipt data to which a receipt service ID is added has been received from the POS terminal 21. The second control unit 73 has a function of acquiring the receipt service ID stored in association with a member ID from the cooperation table 62 when receipt data to which a program member ID is added has been received from the POS terminal 21. The second control unit 73 converts (translates) the program member ID in the receipt data into the associated receipt service ID and transmits the receipt data along with the receipt service ID added thereto to the receipt server 12. The functions as the first control unit 72 and the second control unit 73 are implemented when the processor 51 is in a transaction mode.

The default mode of the processor 51 is the transaction mode. When a cooperation command is received from the external device, the mode is switched to the cooperation mode. When processing of the cooperation mode is ended, the mode returns to the transaction mode. Such mode switching and information processing in the different modes can be executed in accordance with a control program installed in the main memory 52 or the auxiliary storage device 53. The method of installing the control program is not particularly limited. The control program can be installed by recording the control program on a removable recording medium or distributing the control program via a network. The format of the recording medium is not limited as long as the recording medium can store the program and can be read. The recording medium can be an SD memory card or a USB memory in some examples.

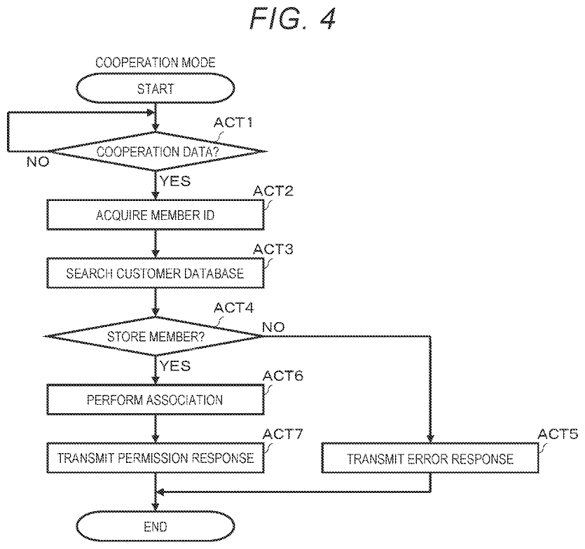

FIG. 4 is a flowchart illustrating a procedure of the processor 51 when the cooperation mode is selected.

When the processor 51 receives the cooperation command from an external device, the processor 51 enters the cooperation mode. The processor 51 then starts the information processing of the procedure illustrated in the flowchart of FIG. 4. First, in ACT 1, the processor 51 waits for the reception of the cooperation data. The cooperation data is transmitted from the transmission source of the cooperation command.

An example of the external device that send the cooperation command is the POS terminal 21. The POS terminal 21 has a cooperation (or linking) menu as one of various operation menus available thereon. When the cooperation menu is selected, the POS terminal 21 can acquire the program member ID of store members and the receipt service ID of receipt members. For example, when data of a membership card is read by a card reader, the POS terminal 21 acquires the program member ID from the membership card. When a barcode of the top screen displayed on the touch panel of the terminal 40 is scanned by a scanner, the POS terminal 21 acquires the receipt service ID from the barcode. The POS terminal 21 then transmits the cooperation data in which the acquired program member ID and the acquired receipt service ID are linked with each other to the customer server 23. The cooperation command and the cooperation data are transmitted to the customer server 23 via the POS server 22.

Another example of an external device that can send the cooperation command is the terminal 40. The terminal 40 (in which the electronic receipt application is activated) may provide the cooperation menu for the receipt member and the store member. When the cooperation menu is selected, the terminal 40 waits for the reception (input) of the program member ID of the store member. The receipt member who uses the terminal 40 operates, for example, a software keyboard displayed on the touch panel to input the program member ID printed on a membership card or the like. Once the program member ID is received by this method, the POS terminal 21 transmits the cooperation data in which the input program member ID and the receipt service ID (set in the terminal 40) are linked with each other to the customer server 23. The cooperation command and the cooperation data are transmitted to the customer server 23 via the relay server 24.

Once the cooperation data is received, the processor 51 proceeds from ACT 1 to ACT 2. In ACT 2, the processor 51 acquires the program member ID from the cooperation data. Then, in ACT 3, the processor 51 searches the customer database 61 for the acquired program member ID. If the customer data corresponding to the acquired program member ID is present in the customer database 61, the consumer identified by the program member ID is a store member. If customer data is not present in the customer database 61 for the acquired program member ID, the consumer is not a store member. For example, if the program member ID is a member ID for another store, such an error event may occur.

In ACT 4, the processor 51 checks whether the user is a store member. If the user is not a store member, the processor 51 proceeds from ACT 4 to ACT 5. In ACT 5, the processor 51 transmits an error response to the external device that sent the cooperation command.

On the other hand, if the user is a store member, the processor 51 proceeds from. ACT 4 to ACT 6. In ACT 6, the processor 51 stores the program member ID and the receipt service ID included in the cooperation data in association with each other in the cooperation table 62. In ACT 7, the processor 51 transmits a permission response to the external device that sent the cooperation command.

In this way, the processor 51 ends the processing in the cooperation mode after transmitting an error response or a permission response. The processor 51 returns to the transaction mode. Here, the processor 51 implements the functions of the association unit 71 by executing the information processing of ACT 1, ACT 2, ACT 3, ACT 4, and ACT 6 in the procedure illustrated in the flowchart of FIG. 4.

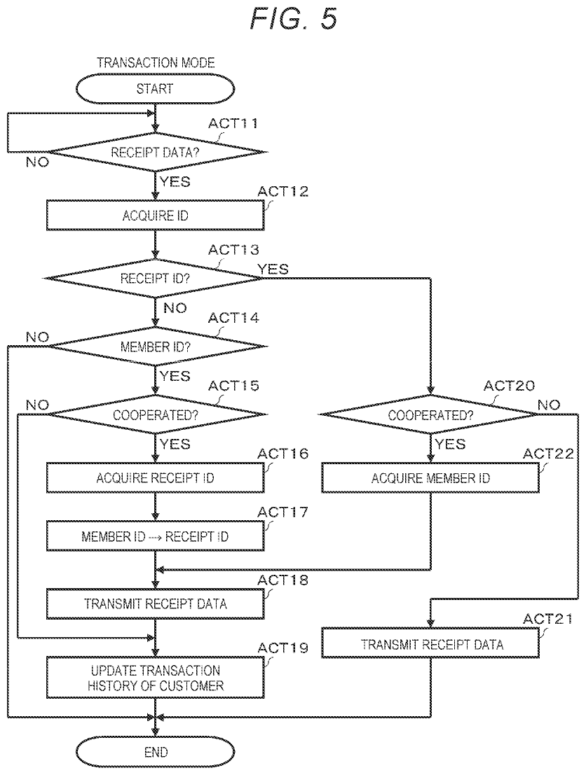

FIG. 5 is a flowchart illustrating a procedure of the processor 51 when the transaction mode is selected.

In ACT 11, the processor 51 (operating in the transaction mode) waits for the reception of receipt data. The receipt data is transmitted from the POS terminal 21 at which the transaction with the consumer is settled. When the transaction with the consumer is settled in the POS terminal 21, the receipt data indicating details of the transaction is generated and transmitted to the customer server 23.

Here, when the barcode of the receipt service ID displayed on the terminal 40 is read by the scanner of the POS terminal 21, the receipt service ID is added to the receipt data. When the membership card of the consumer is read by the card reader of the POS terminal 21, the program member ID is added to the receipt data.

When the processor 51 receives the receipt data via the POS server 22, the process proceeds from ACT 11 to ACT 12. In ACT 12, the processor 51 acquires an ID from the receipt data. In ACT 13, the processor 51 confirms whether the receipt service ID can be acquired from the receipt data. If the receipt service ID can not be acquired, the processor 51 checks whether the program member ID can be acquired from the receipt data in ACT 14. If neither the receipt service ID nor the program member ID can be acquired, the processor 51 ends the information processing of the procedure illustrated in the flowchart of FIG. 5.

If the program member ID is acquired from the receipt data, the processor 51 proceeds from ACT 14 to ACT 15. In ACT the processor 51 searches the cooperation table 62 and checks whether a receipt service ID is associated with the acquired program member ID. If a receipt service ID is not associated with the program member ID, the store member matching the program member ID is not identified as a receipt member. The processor 51 proceeds from ACT 15 to ACT 19. In ACT 19, the processor 51 updates, based on the receipt data, information in the transaction history of the customer matching the program member ID. The processor 51 then ends the information processing of the procedure illustrated in the flowchart of FIG. 5.

If a receipt service ID is associated with the program member ID, the store member matching the program member ID is linked as a receipt member. The processor 51 proceeds from ACT to ACT 16. In ACT 16, the processor 51 acquires the receipt ID associated with the member ID from the cooperation table 62. In ACT 17, the processor 51 converts (translates) the program member ID in the receipt data into the receipt service ID acquired in the processing of ACT 16. In ACT 18, the processor 51 controls the communication interface 54 to transmit receipt data in which the program member ID is replaced with a receipt service ID to the receipt server 12. By this control, the receipt data is transmitted from the communication interface 54 to the relay server 24, and is further transmitted to the receipt server 12 via the communication network 30.

The processor 51 that controls the transmission of the receipt data proceeds to ACT 19. In ACT 19, the processor 51 updates, based on the receipt data, the transaction history for the program member ID added to the receipt data. The processor 51 then ends the information processing of the procedure illustrated in the flowchart of FIG. 5.

On the other hand, if a receipt service ID is acquired from the receipt data, the processor 51 proceeds from ACT 13 to ACT 20. In ACT 20, the processor 51 searches the cooperation table 62 and checks whether a program member ID is associated with the acquired receipt service ID. If a program member ID is not associated with the receipt service ID, the receipt member identified by the receipt ID is not linked as a store member. The processor 51 proceeds from ACT 20 to ACT 21. In ACT 21, the processor 51 controls the communication interface 54 to transmit the receipt data to the receipt server 12. The processor 51 then ends the information processing of the procedure illustrated in the flowchart of FIG. 5.

If a program member ID is associated with the receipt service ID, the receipt member identified by the receipt service ID is linked as a store member. The processor 51 proceeds from ACT 20 to ACT 22. In ACT 22, the processor 51 acquires the program member ID associated with the receipt service ID from the cooperation table 62. Then, the processor 51 executes the processing of ACT 18 and ACT 19 as described above.

That is, in ACT 18, the processor 51 controls the communication interface 54 to transmit the receipt data to which the receipt service ID has been added to the receipt server 12. Then, in ACT 19, the processor 51 updates, based on the receipt data, the transaction history of the customer associated with the program member ID acquired in ACT 22. The processor 51 then ends the information processing of the procedure illustrated in the flowchart of FIG. 5.

As described above, the processor 51 implements the functions as a first control unit 72 by executing the processing of ACT 11, ACT 12, ACT 13, ACT 20, and ACT 21 or ACT 18 in the procedure illustrated in the flowchart of FIG. 5. The processor 51 implements the functions as a second control unit 73 by executing the processing of ACT 11, ACT 12, ACT 13, ACT 14, ACT ACT 16, ACT 17, and ACT 18 in the procedure illustrated in the flowchart of FIG. 5.

### Operation and Effect of Electronic Receipt System

In the electronic receipt system 100, the customer server 23 of the store system 20 includes the cooperation table 62. When a program member ID linked with the receipt service ID in the cooperation table 62 is added to the receipt data of the transaction settled at the POS terminal 21, the customer server 23 converts the program member ID in the receipt data into the corresponding receipt service ID. Then, receipt data to which the receipt service ID has been added is transmitted to the receipt server 12 via the relay server 24.

Therefore, the program member ID is not included in the receipt data output from the store system 20 to the electronic receipt center 10. Therefore, there is no need to provide any additional information about the store member associated with the program member ID to the entity that operates the electronic receipt system. Therefore, the store program memberships and receipt service memberships can be linked with each other without providing store member information from the store to the entity that operates the electronic receipt system. Since information about the store member is not provided to the institution that operates the electronic receipt system, even when a linkage between a program member ID and a receipt service ID is canceled, the cancellation can be completed by internal processing of the store system 20.

In addition, when the receipt service ID is added to the receipt data, the receipt data is transmitted to the receipt server 12 via the relay server 24. Here, when the receipt service ID is linkage with a program member ID in the cooperation table 62, the customer server 23 updates, based on the receipt data, the transaction history of the store member identified by the program member ID. Therefore, for example, even when the store member identified by a program member ID associated with a receipt service ID forgets a program membership card or the like, the store member can still receive a privilege/benefit provided only to the store members such as points can be awarded as part of a point service as long as the store member has the terminal 40 with the electronic receipt application installed at the time of checkout. Of course, the transaction receipt at this time can be provided to the store member as an electronic receipt.

### Modification

In an embodiment, the store system 20 includes the POS server 22, the customer server 23, and the relay server 24. In some examples, servers 22, 23 24 might not be independent from one another. For example, the POS server 22 may also provide a function as a customer server 23. Alternatively, the relay server 24 may function as the customer server 23. In addition, functions as the POS server 22, the customer server 23, and the relay server 24 may be implemented by a single server.

While certain embodiments have been described, these embodiments have been presented by way of example only, and are not intended to limit the scope of the disclosure. Such new embodiments can be implemented in other various forms, and various omissions, replacements, and changes can be made without departing from the spirit of the embodiments. These embodiments and the modifications thereof are included in the scope of the embodiment and are also included in the embodiment described in the claims and an equivalent scope thereof.

What is claimed is:

1. An electronic receipt system, comprising:
a first server configured to store first identification codes set for customers who are program members who have joined a customer program of a store; and
a second server configured to store second identification codes set for receipt service members who have joined an electronic receipt service managed by an institution other than the store for receiving electronic transaction receipts from the store, wherein
the first server comprises:
a storage unit to store first identification codes of program members in association with second identification code for those who are also receipt service members;
a first control unit configured to receive receipt data including a second identification code from a settlement terminal of the store for a customer transaction then transmit the receipt data with the received second identification code to the second server; and
a second control unit configured to receive receipt data including a first identification code from the settlement terminal of the store for a customer transaction and acquire a second identification code stored in association with the received first identification code from the storage unit and add the acquired second identification code to the receipt data and transmit the receipt data to the second server without the including the first identification code.

2. The electronic receipt system according to claim 1, wherein the first server further comprises:
an association unit configured to check whether a first identification code in cooperation data received from an outside source is in the storage unit. is associated with a second identification code in the storage unit of the first server.

3. The electronic receipt system according to claim 2, wherein the association unit is further configured to add a second identification code associated with the first identification code in the cooperation data to the storage unit of the first server.

4. The electronic receipt system according to claim 2, further comprising:
a third server connected to the settlement terminal and managing registration of items in the customer transaction and generating the receipt data sent to the first server.

5. The electronic receipt system according to claim 4, further comprising:
a fourth server connected between the first server and the second server and configured to manage communication between the first server and the second server.

6. The electronic receipt system according to claim 1, further comprising:
a third server connected to the settlement terminal and managing registration of items in the customer transaction and generating the receipt data sent to the first server.

7. The electronic receipt system according to claim 6, further comprising:
a fourth server connected between the first server and the second server and configured to manage communication between the first server and the second server.

8. An electronic receipt system, comprising:
an electronic receipt server of an electronic receipt service provided to a plurality of members and a plurality of stores, each member of the electronic receipt service having a receipt service ID; and
a plurality of store systems corresponding to the plurality of stores, each store system providing a customer loyalty program, each customer of the customer program having a program member ID, the plurality of store systems being connected to the electronic receipt server by a network connection, wherein
each store system includes:
a point-of-sale terminal at which a customer can settle a sales transaction and enter a receipt service ID or a program member ID;
a POS server configured to receive receipt data from the point-of-sale terminal along with a receipt service ID or a program member ID entered in the sales transaction; and
a customer server configured to:
receive the receipt data from the POS server,
determine whether the received receipt data includes a receipt service ID or a program member ID,
if the receipt data includes a receipt service ID, transmit the receipt data to the electronic receipt server and determine if the receipt service ID is associated with a program member ID and then, if so, update transaction data in a transaction history associated with the associated program member ID according to the receipt data, and
if the receipt data includes a program member ID, determine if the program member ID is associated with a receipt service ID and then, if so, switch the program member ID in the receipt data with the associated receipt service ID, transmit the receipt data to the electronic receipt server with the switched receipt service ID, and update transaction data in a transaction history associated with program member ID according to the receipt data.

9. A server for use in an electronic receipt system, the server comprising:
a storage unit including a customer database associating customers to program member IDs and a cooperation table associating program member IDs to electronic receipt service IDs; and
a processor configured to:
receive receipt data including a second identification code from a settlement terminal of the store for a customer transaction at the store then transmit the receipt data with the received second identification code to the second server; and
a second control unit configured to receive receipt data including a first identification code from the settlement terminal of the store for a customer transaction and acquire a second identification code stored in association with the received first identification code from the storage unit, add the acquired second identification code to the receipt data and transmit the receipt data to the second server without the including the first identification code.

10. The server according to claim 9, wherein the processor is further configured to receive cooperation data from an external source, the cooperation data associating a first identification code to a second identification code.

11. The server according to claim 10, wherein the processor is further configured to confirm the first identification code in the cooperation data is in the customer database.

12. The server according to claim 11, wherein the processor is further configured to add the second identification code in the cooperation data to the customer database in association with the first identification code in the cooperation data.
